(19) United States
(12) Patent Application Publication
(10) Pub. No.: US 2026/0133759 A1
(43) Pub. Date: May 14, 2026

(54) RIPPLE CARRY FULL ADDER CIRCUIT

(71) Applicant: Samsung Electronics Co., Ltd., Suwon-si (KR)

(72) Inventors: Mitesh GOYAL, Bengaluru (IN); Somya AGARWAL, Bengaluru (IN); Pallav BOSE, Bengaluru (IN); Avinash MAURYA, Bengaluru (IN); Debojyoti BANERJEE, Bengaluru (IN)

(73) Assignee: Samsung Electronics Co., Ltd., Suwon-si (KR)

(21) Appl. No.: 19/206,698

(22) Filed: May 13, 2025

(30) Foreign Application Priority Data
Nov. 8, 2024 (IN) 202441086035
Feb. 28, 2025 (IN) 202441086035

(51) Int. Cl. G06F 7/501

(52) U.S. Cl. CPC G06F 7/501

(57) ABSTRACT

The present disclosure provides a ripple carry full adder circuit including a sum generation circuit that includes a first bit generation circuit and a second bit generation circuit, where the first bit generation circuit is configured to generate a first output sum signal, and the second bit generation circuit is configured to generate a second output sum signal; and a carry bit generation circuit that is configured to generate an output carry signal, where the carry bit generation circuit comprises a compute logic circuit and a ripple carry generation circuit, the ripple carry generation circuit further including a plurality of carry bit generation NAND gates; the first bit generation circuit having a first NOR gate, a first logic circuit, a first inverter, and a second logic circuit, and the second bit generation circuit having a second NOR gate, a third logic circuit, a fourth inverter, and a fourth logic circuit.

### CROSS-REFERENCE TO RELATED APPLICATION

The present application claims priority under 35 U.S.C § 119 to Indian Provisional Patent Application No. 202441086035, filed on Nov. 8, 2024, and Indian Non-Provisional Patent Application No. 202441086035, filed on Feb. 28, 2025, in the Indian Intellectual Property Office, the disclosures of which are hereby incorporated by reference in their entireties.

### BACKGROUND

The present disclosure relates to higher-performance digital integrated circuits associated with implementation of a Ripple Carry Full Adder Circuit.

In recent developments in system on chips (SoCs), full adders may be computationally heavy blocks of the SoC. The various units of the SoCs that consume power are logic implementation, full adders, flip flops, random access memory (RAM), clock tree, and integrated clock gating (ICG) cells. The full adders may cover most of the total area of the SoCs and consume one-third of the total power in a typical digital design. Further, full adders are the most critical combinational logic cell for artificial intelligence (AI)/machine learning (ML) and high-performance computing (HPC) applications. A full adder circuit generates a sum and a carryout bit (CO). The carryout bit (CO) is generated from the adder input operands A and B, and the adder input carryin (CI) from a previous addition operation. Conventional full adders are designed for low-power delay and the lowest possible area. However, for applications that require high time constraint designs very low latency for carryin (CI) to carryout (CO) paths are required. Further, many bits of data are available in a timing-constrained path in full adder circuits.

A 2-bit full adder circuit has five inputs (A0, B0, A1, B1, and carryin (CI)) and has three outputs (S0, S1, carryout (CO)). The path between CI to CO is the most timing-critical path in the full adder. However, a regular ripple carry adder has four stages of delay from CI to CO and also has high input capacitance on relevant nets in reference circuits. As an example, FIG. 1A illustrates a conventional two-bit ripple carry full adder circuit 100, in accordance with prior art. As shown in FIG. 1A, the two-bit ripple carry full adder circuit 100 consists of two identical one-bit ripple carry full adder circuits 101a and 101b appended together. The first one-bit ripple carry full adder circuit 101a receives first and second input bits (A0, B0) and a carry input carryin (Cin). The first one-bit ripple carry full adder circuit 101a provides a first output bit (S0) and intermediate carry output (CO). The second one-bit ripple carry full adder circuit 101b receives third and fourth input bits (A1, B1) and the intermediate carry output (CO). The second one-bit ripple carry full adder circuit 101b provides a second output bit (S1) and a carry output carryout (Cout). Each adder 101a, 101b has inputs (A, B, CI) and two stages for carryin to carryout path. Carry output CO of the first bit adder circuit 101a is connected to carry input CI of the second bit adder circuit 101b. Accordingly, 4 stages are created from carryin pin (CI) to carryout (Cout). In the existing adder, carryin pin (CI) is connected to 6 transistors while the output stage (CO, S) is connected to 4 transistors. This heavy loading of transistors results in a reduction in the speed of the ripple carry full adder circuit 100.

A detailed circuit of the one-bit ripple carry full adder circuit is further shown in FIG. 1B. It should be noted that since the first and second one-bit ripple carry full adder circuits are identical, only the first one-bit ripple carry full adder circuit 101a has been shown in FIG. 1B. As shown in FIG. 1B, the one-bit ripple carry full adder circuit 101a uses 28 transistors, which result in reduction in the speed of the one-bit ripple carry full adder circuit 101a.

Further, in related full adder circuits, each input (A0, B0, A1, B1, and CI) is connected in a cascaded manner. This degrades the internal propagation delay of the circuit. Also, the full adder circuits in related art are not optimized for two critical A0B1 and A1B0 input states. While some circuits in related art are inputs-pass gates based, they have low reliability to noise and include signal deformities due to coupling.

Therefore, there exists a strong need to develop an improved full adder circuit while addressing the aforementioned challenges.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

According to one embodiment of the present disclosure, a ripple carry full adder circuit is disclosed. The circuit includes a sum generation circuit, the sum generation circuit comprising a first bit generation circuit and a second bit generation circuit, wherein the first bit generation circuit is configured to generate a first output sum signal, and the second bit generation circuit is configured to generate a second output sum signal; and a carry bit generation circuit configured to generate an output carry signal, wherein the carry bit generation circuit comprises a compute logic circuit and a ripple carry generation circuit, the ripple carry generation circuit comprising a plurality of carry bit generation NAND gates; where the first bit generation circuit comprises a first NOR gate, a first logic circuit, a first inverter, and a second logic circuit, and where the second bit generation circuit comprises a second NOR gate, a third logic circuit, a fourth inverter, and a fourth logic circuit.

According to one embodiment of the present disclosure, an electronic device comprising a ripple carry full adder circuit is provided. The ripple carry full adder circuit includes a sum generation circuit, the sum generation circuit comprising a first bit generation circuit and a second bit generation circuit, wherein the first bit generation circuit is configured to generate a first output sum signal, and the second bit generation circuit is configured to generate a second output sum signal; and a carry bit generation circuit configured to generate an output carry signal, wherein the carry bit generation circuit comprises a compute logic circuit and a ripple carry generation circuit, the ripple carry generation circuit having a plurality of carry bit generation NAND gates; where the first bit generation circuit comprises a first NOR gate, a first logic circuit, a first inverter, and a second logic circuit, and where the second bit generation circuit comprises a second NOR gate, a third logic circuit, a fourth inverter, and a fourth logic circuit.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIGS. 1A-1B illustrate exemplary full adder circuit, in accordance with related art;

FIG. 2 illustrates a block diagram of a ripple carry full adder circuit, in accordance with some example embodiments of the present disclosure;

FIG. 3 illustrates an exemplary circuit architecture of a first bit generation circuit, in accordance with some example embodiments of the present disclosure;

FIG. 4 illustrates an exemplary circuit architecture of a first bit generation circuit, in accordance with some example embodiments of the present disclosure;

FIG. 5 illustrates an exemplary circuit architecture of a first bit generation circuit, in accordance with some example embodiments of the present disclosure;

FIG. 6 illustrates an exemplary circuit architecture of a second bit generation circuit, in accordance with some example embodiments of the present disclosure;

FIG. 7 illustrates an exemplary circuit architecture of a second bit generation circuit, in accordance with some example embodiments of the present disclosure;

FIG. 8 illustrates an exemplary circuit architecture of a second bit generation circuit, in accordance with some example embodiments of the present disclosure;

FIG. 9 illustrates a circuit architecture of a carry bit generation (COG) circuit, in accordance with some example embodiments of the present disclosure; and

FIG. 10 illustrates a computing system, in accordance with some example embodiments of the present inventive concepts.

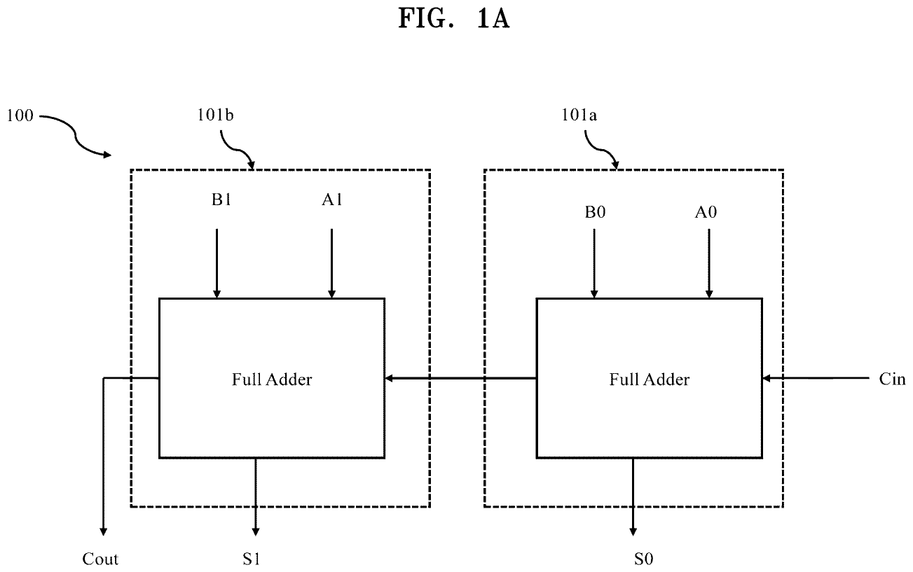

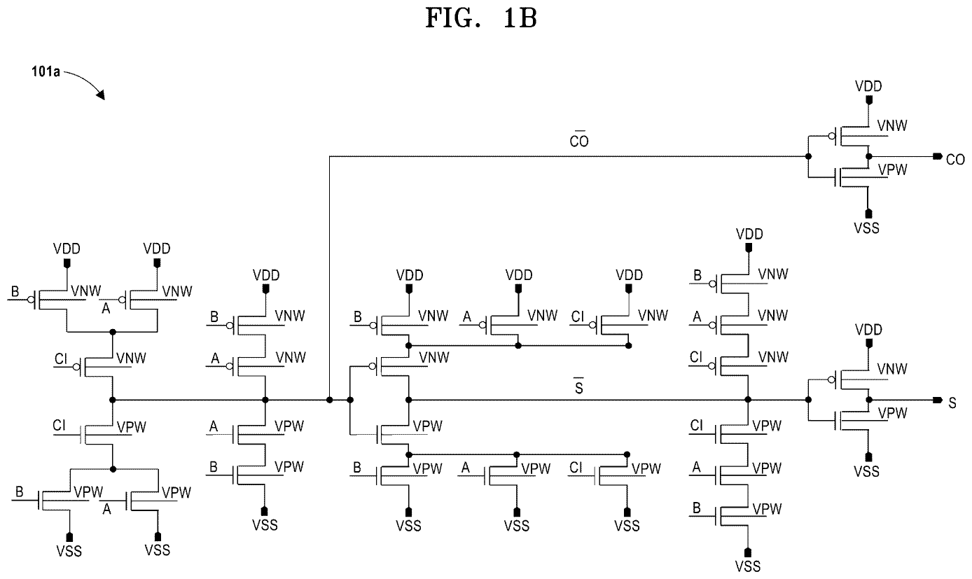

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the circuit, one or more components of the circuit may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more systems or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Whether or not a certain feature or element was described in singular form, it may still be referred to as “one or more features” or “one or more elements” or “at least one feature” or “at least one element.” Furthermore, the use of the terms “one or more” or “at least one” feature or element does not preclude there being none of that feature or element unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

Example embodiments of the present inventive concepts will be described below in detail with reference to the accompanying drawings.

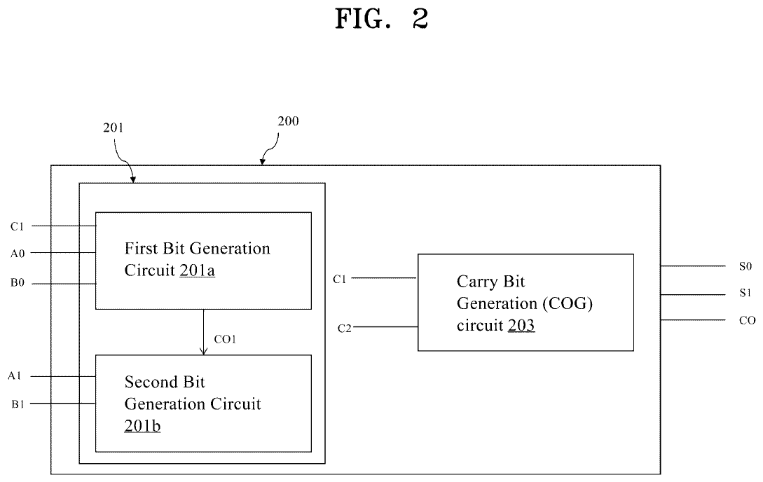

FIG. 2 illustrates a block diagram of a ripple carry full adder circuit 200, in accordance with some example embodiments of the present disclosure. As shown in FIG. 2, the ripple carry full adder circuit 200 may include a sum generation (SG) circuit 201, and a carry bit generation (COG) circuit 203. The SG circuit 201 may include the first bit generation circuit 201a configured to generate a first output signal or first output sum signal (S0), and a second bit generation 201b circuit is configured to generate a second output signal or second output sum signal (S1). The first bit generation circuit 201a includes a first NOR gate, a first logic circuit, a first inverter, and a second logic circuit. The second bit generation circuit 201b includes a second NOR gate, a third logic circuit, one or more second inverters, and a fourth logic circuit. The COG circuit 203 is configured to generate an output carry signal (CO). The COG circuit includes a compute logic circuit and a ripple carry generation circuit including a plurality of COG NAND gates. The aforementioned circuit components of the ripple carry full adder circuit 200 are coupled with each other, but the disclosure is not limited thereto. The detailed interconnection and working of each of the circuit components will be explained in the forthcoming paragraphs. Further, the reference numerals are kept the same wherever applicable for the sake of simplicity and ease of explanation. Further, it should be noted that the symbol Ø and 0 have been used interchangeably throughout the description and drawings.

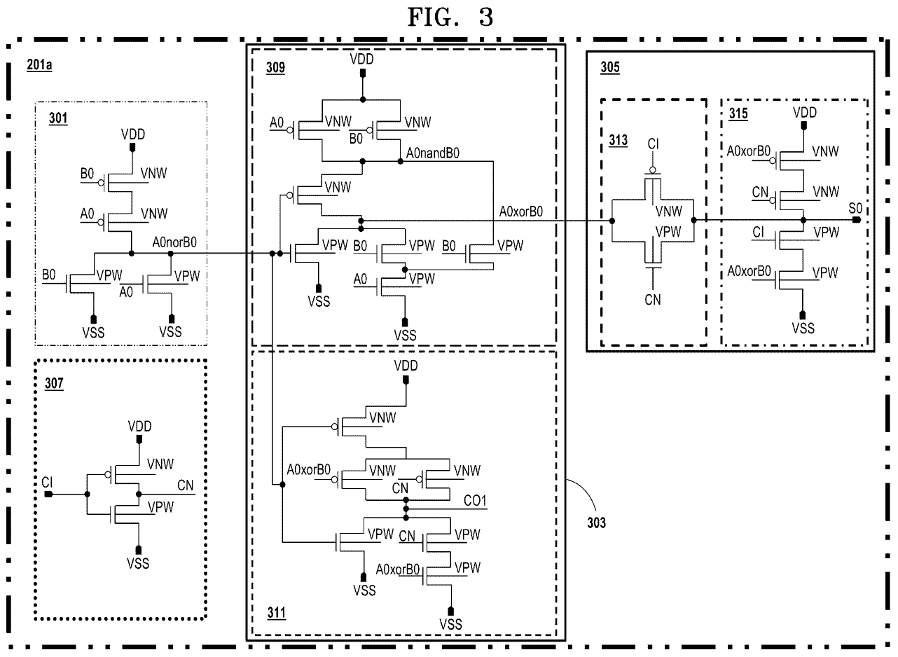

FIGS. 3-5 illustrate circuit architectures of a first bit generation circuit 201a, in accordance with some example embodiments of the present disclosure.

FIG. 3 illustrates the first bit generation circuit 201a, in accordance with some example embodiments of the present disclosure. As shown in FIG. 3, in an embodiment, the first bit generation circuit 201a includes a first NOR gate 301, a first logic circuit 303, a second logic circuit 305, and a first inverter 307. As shown, a first input bit (A0) and a second input bit (B0) are provided to a 2-input first NOR gate 301 to generate a first NOR signal (A0norB0). The first NOR signal (e.g., A0norB0) is further fed to the first logic circuit 303. The first logic circuit 303 comprises a first NAND gate connected in parallel with a first AND-OR-Invert (AOI) gate 309 and a second AOI gate 311. The first logic circuit 303 generates an AND signal (e.g., A0andB0) by performing an AND operation on the input bits A0 and B0. In an embodiment, the first logic circuit 303 performs an OR operation on the generated AND signal (e.g., A0andB0) and the first NOR signal (e.g., A0norB0) to generate a first XOR signal (e.g., A0xorB0) signal. The input bits A0 and B0 are fed to the first NAND gate to generate a first NAND signal (e.g., A0nandB0). Further, an input carry signal (CI) is fed to the first inverter 307 to generate an inverted carry signal (CN).

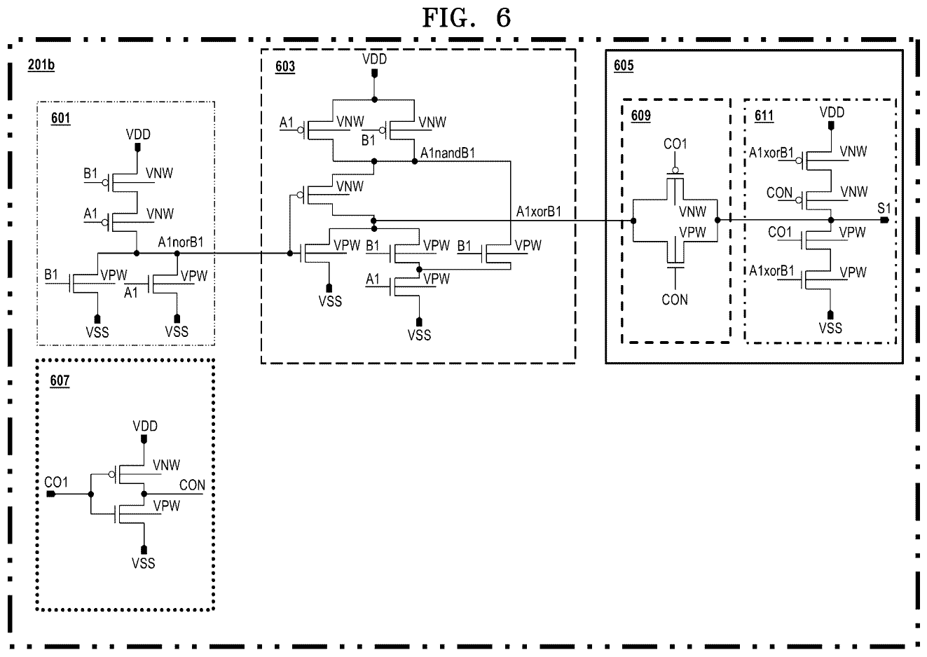

The second logic circuit 305 comprises a first transmission gate 313 and a first tristate inverter gate 315. In the second logic circuit 305, the first XOR signal (e.g., A0xorB0) is further fed to the first transmission gate 313 controlled by CI and CN signals. The output of the first transmission gate 313 is connected to the output of the first tristate inverter gate 315 to generate the first output sum signal (S0). The first tristate inverter gate 315 is controlled by CI and CN signals and inverts the first XOR signal (e.g., A0xorB0). The first bit generation circuit 201a is further configured to generate an intermediate carry out signal (CO1). In particular, the second AOI gate 311 performs an AND operation on the first XOR signal (e.g., A0xorB0) and the inverted carry signal (CN). The first bit generation circuit 201a further performs an OR operation on the first NOR signal (e.g., A0norB0) and the output of the second AOI gate 311 to generate the intermediate carry out signal (CO1). The intermediate carry out signal (CO1) is used to generate the second output sum signal (S1) by the second bit generation circuit 201b, which will further be explained in reference to FIGS. 6-8.

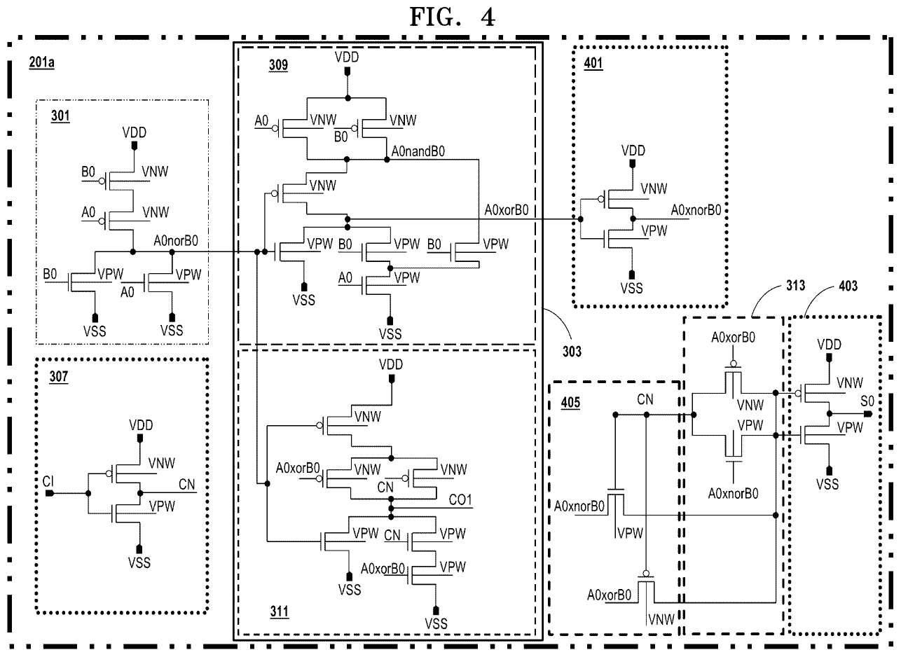

FIG. 4 illustrates the first bit generation circuit 201a, in accordance with some example embodiments of the present disclosure.

As shown in FIG. 4, in another embodiment, the first bit generation circuit 201a includes the first NOR gate 301, the first logic circuit 303, the second logic circuit 305, and the first inverter 307. As shown, the first input bit (A0) and the second input bit (B0) are provided to the 2-input first NOR gate 301 to generate the first NOR signal (e.g., A0norB0). The first NOR signal (e.g., A0norB0) is further fed to the first logic circuit 303. The first logic circuit 303 comprises a first NAND gate connected in parallel with a first AND-OR-Invert (AOI) gate 309 and a second AOI gate 311. The first logic circuit 303 generates an AND signal (e.g., A0andB0) by performing an AND operation on the input bits A0 and B0. In an embodiment, the first logic circuit 303 performs an OR operation on the generated AND signal (e.g., A0andB0) and the first NOR signal (e.g., A0norB0) to generate a first XOR signal (e.g., A0xorB0) signal. In an embodiment, the input bits A0 and B0 are fed to the first NAND gate to generate the first NAND signal (e.g., A0nandB0). Then, the input carry signal (CI) is fed to the first inverter 307 to generate the inverted carry signal (CN).

The second logic circuit 305 comprises a pass transistor 405, a first transmission gate 313, a second inverter 401, and a third inverter 403. In the second logic circuit 305, the first XOR signal (e.g., A0xorB0) signal is further fed to a second inverter 401 to generate a first XNOR signal (e.g., A0xnorB0). The first XNOR signal (e.g., A0xnorB0) and the first XOR signal (e.g., A0xorB0) are further fed to the pass transistor 405 controlled by the CN signal. The output of the pass transistor 405 is connected to the input of the first transmission gate 313. The other input to the first transmission gate 313 is the CN signal and the first transmission gate 313 is controlled by the first XNOR signal (e.g., A0xnorB0) and the first XOR signal (e.g., A0xorB0). The outputs of the first transmission gate 313 and the pass transistor 405 are fed to the third inverter 403 to generate the first output sum signal (S0). The first bit generation circuit 201a is further configured to generate an intermediate carry out signal (CO1). In particular, the second AOI gate 311 performs an AND operation on the first XOR signal (e.g., A0xorB0) and the inverted carry signal (CN). The first bit generation circuit 201a further performs an OR operation on the first NOR signal (e.g., A0norB0) and the output of the second AOI gate 311 to generate the intermediate carry out signal (CO1). The intermediate carry out signal (CO1) is used to generate the second output sum signal (S1) by the second bit generation circuit 201b, which will further be explained in reference to FIGS. 6-8.

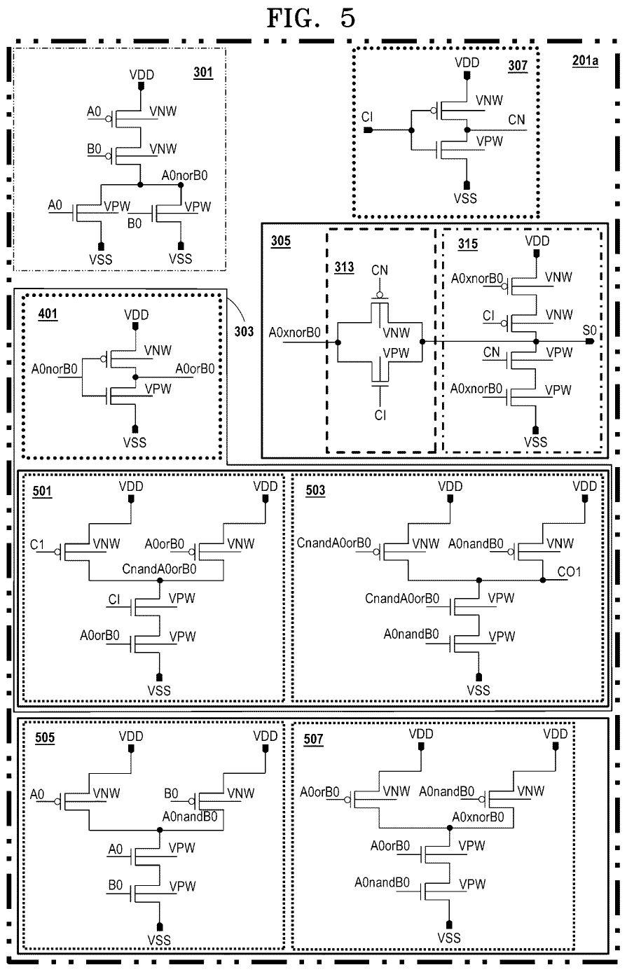

FIG. 5 illustrates the first bit generation circuit 201a, in accordance with some example embodiments of the present disclosure.

As shown in FIG. 5, in another embodiment, the first bit generation circuit 201a includes the first NOR gate 301, the first logic circuit 303, the second logic circuit 305, and the first inverter 307. As shown, the first input bit (A0) and the second input bit (B0) are provided to the 2-input first NOR gate 301 to generate the first NOR signal (e.g., A0norB0). The first NOR signal (e.g., A0norB0) is further fed to the first logic circuit 303. The first logic circuit 303 comprises a first NAND gate 501 connected with a second NAND gate 503 and the second inverter 401. The first NOR signal (e.g., A0norB0) is fed to the second inverter 401 which generates a first OR signal (e.g., A0orB0). In an embodiment, the input bits A0 and B0 are fed to the first NAND gate 501 to generate the first NAND signal (e.g., A0nandB0). The first NAND signal (e.g., A0nandB0) and the first OR signal (e.g., A0orB0) are fed to the second NAND gate 503 to generate a first XNOR signal (e.g., A0xnorB0). Then, the input carry signal (CI) is fed to the first inverter 307 to generate the inverted carry signal (CN).

The second logic circuit 305 comprises a first transmission gate 313 and a first tristate inverter gate 315. In the second logic circuit 305, the first XNOR signal (e.g., A0xnorB0) is further fed to the first transmission gate 313 controlled by CI and CN signals. The output of the first transmission gate 313 is connected to the output of the first tristate inverter gate 315 to generate the first output sum signal (S0). The first tristate inverter gate 315 is controlled by CI and CN signals and inverts the first XNOR signal (e.g., A0xnorB0). The first bit generation circuit 201a is further configured to generate the intermediate carry out signal (CO1). In particular, the first bit generation circuit 201a further comprises a third NAND gate 605 connected with a fourth NAND gate 607. The input carry signal (CI) and the first OR signal (e.g., A0orB0) are fed to the third NAND gate 605 which generates a CnandA0orB0 signal. This generated CnandA0orB0 signal is further fed to the fourth NAND gate 607 along with the first NAND signal A0nandB0 to generate the intermediate carry out signal (CO1). The intermediate carry out signal (CO1) is used to generate the second output sum signal (S1) by the second bit generation circuit 201b, which will further be explained in reference to FIGS. 6-8. Persons of skill in the art would understand that FIGS. 3-5 are non-limiting embodiments of the present disclosure.

FIG. 6 illustrates the second bit generation circuit 201b, in accordance with some example embodiments of the present disclosure.

As shown in FIG. 6, in an embodiment, the second bit generation circuit 201b includes a second NOR gate 601, a third logic circuit 603, a fourth inverter 607, and a fourth logic circuit 605. As shown, a third input bit (A1) and a fourth input bit (B1) are provided to a 2-input second NOR 601 gate to generate a second NOR signal (e.g., A1norB1). The second NOR signal (e.g., A1norB1) is further fed to the third logic circuit 603. The third circuit 603 comprises a fifth NAND gate connected in parallel with a second AND-OR-Invert (AOI) gate and the fourth inverter 607. The third logic circuit 603 generates an AND signal (e.g., A0andB0) by performing an AND operation on the input bits A1 and B1. In an embodiment, the third logic circuit 603 performs an OR operation on the generated AND signal (e.g., A1andB1) and the second NOR signal (e.g., A1norB1) to generate a second XOR signal (e.g., A1xorB1) signal. The input bits A1 and B1 are fed to the fifth NAND gate to generate a second NAND signal (e.g., A1nandB1). Then, the intermediate carry out signal (CO1) is fed to the fourth inverter 607 to generate an inverted intermediate carry out signal (CON).

The fourth logic circuit 605 comprises a second transmission gate 609 and a second tristate inverter gate 611. In the fourth logic circuit 605, the second XOR signal (e.g., A1xorB1) is further fed to the second transmission gate 609 controlled by CO1 and CON signals. The output of the second transmission gate 609 is connected to the output of the second tristate inverter gate 611 to generate the second output sum signal (S1). The second tristate inverter gate 611 is controlled by CO1 and CON signals and inverts the second XOR signal (e.g., A1xorB1).

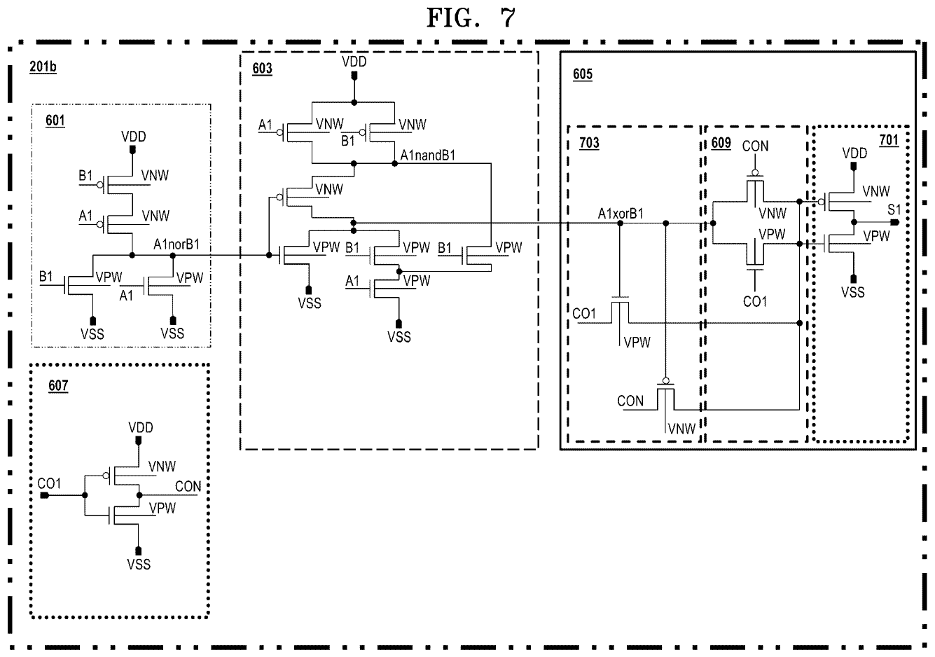

FIG. 7 illustrates the second bit generation circuit 201b, in accordance with some example embodiments of the present disclosure.

As shown in FIG. 7, in another embodiment, the second bit generation circuit 201b includes the second NOR gate 601, the third logic circuit 603, the third inverter 607 and the fourth logic circuit 605. As shown, the third input bit (A1) and the fourth input bit (B1) are provided to the 2-input second NOR 601 gate to generate the second NOR signal (e.g., A1norB1). The second NOR signal (e.g., A1norB1) is further fed to the third logic circuit 603. The third logic circuit 603 comprises the fifth NAND gate connected in parallel with the second AND-OR-Invert (AOI) gate and the third inverter 607. The third logic circuit 603 generates an AND signal (e.g., A0andB0) by performing an AND operation on the input bits A1 and B1. In an embodiment, the third logic circuit 603 performs an OR operation on the generated AND signal (e.g., A1andB1) and the second NOR signal (e.g., A1norB1) to generate a second XOR signal (e.g., A1xorB1) signal. The input bits A1 and B1 are fed to the fifth NAND gate to generate a second NAND signal (e.g., A1nandB1). Then, the intermediate carry out signal (CO1) is fed to the fourth inverter 607 to generate an inverted intermediate carry out signal (CON).

The fourth logic circuit 605 comprises a plurality of pass transistors 703, the second transmission gate 609, and a fifth inverter 701. In the fourth logic circuit 605, CO1 and CON signals are further fed to the plurality of pass transistors 703 controlled by the second XOR signal (e.g., A1xorB1). The output of the plurality of pass transistor 703 is connected to the input of the second transmission gate 609. The other input to the second transmission gate 609 is the second XOR signal (e.g., A1xorB1) and the second transmission gate 609 is controlled by CO1 and CON. The outputs of the second transmission gate 609 and the plurality of pass transistor 703 are fed to the fifth inverter 701 to generate the second output sum signal (S1).

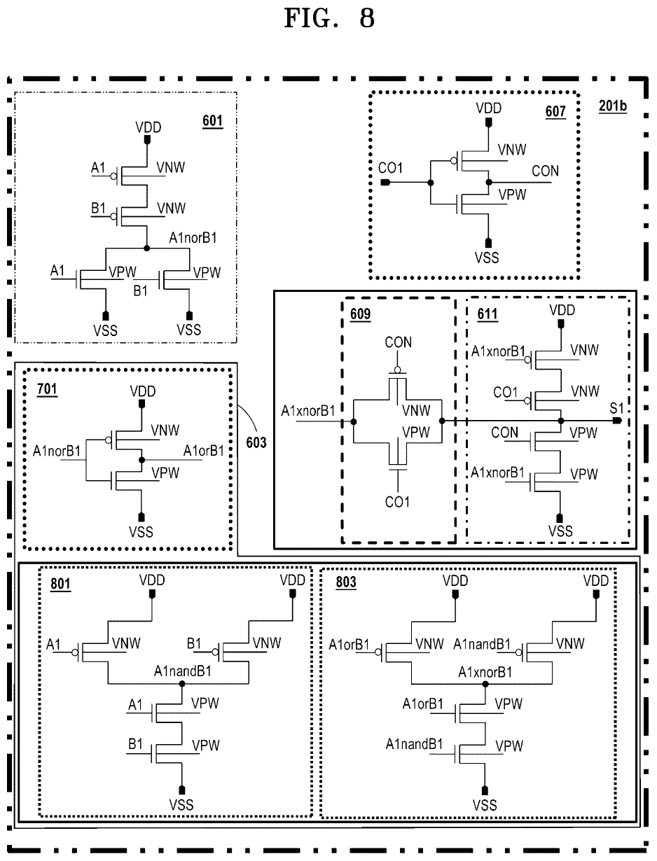

FIG. 8 illustrates the second bit generation circuit 201b, in accordance with some example embodiments of the present disclosure.

As shown in FIG. 8, in another embodiment, the second bit generation circuit 201b includes the second NOR gate 601, the third logic circuit 603, the fourth logic circuit 605, and the fourth inverter 607. As shown, the third input bit (A1) and the fourth input bit (B1) are provided to the 2-input second NOR gate 601 to generate the second NOR signal (e.g., A1norB1). The second NOR signal (e.g., A1norB1) is further fed to the third logic circuit 603. The third logic circuit 603 comprises a fifth NAND gate 801 connected with a sixth NAND gate 803 and a fifth inverter 701. The second NOR signal (e.g., A1norB1) is fed to the fifth inverter 701 which generates a second OR signal (e.g., A1orB1). In an embodiment, the input bits A1 and B1 are fed to the fifth NAND gate 801 to generate the second NAND signal (e.g., A1nandB1). The second NAND signal (e.g., A1nandB1) and the second OR signal (e.g., A1orB1) are fed to the sixth NAND gate 803 to generate a second XNOR signal (e.g., A1xnorB1). Then, the intermediate carry out signal (CO1) is fed to the fourth inverter 607 to generate an inverted intermediate carry out signal (CON).

The fourth logic circuit 605 comprises a second transmission gate 609 and a second tristate inverter gate 611. In the fourth logic circuit 605, the second XNOR signal (e.g., A1xnorB1) is further fed to the second transmission gate 609 controlled by CO1 and CON signals. The output of the second transmission gate 609 is connected to the output of the second tristate inverter gate 611 to generate the second output sum signal (S1). The second tristate inverter gate 611 is controlled by CO1 and CON signals and inverts the second XNOR signal (e.g., A1xnorB1). Persons of skill in the art would understand that FIGS. 6-8 are non-limiting embodiments of the present disclosure.

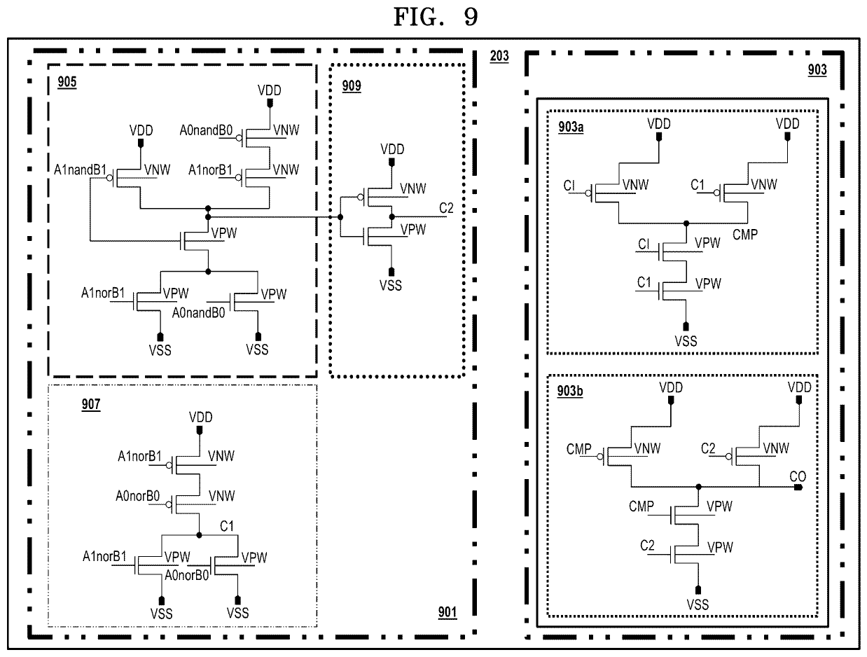

FIG. 9 illustrates a circuit architecture of the carry bit generation (COG) circuit, in accordance with some example embodiments of the present disclosure. As shown in FIG. 9, in an embodiment, the COG 203 includes the compute logic circuit 901 and the ripple carry generation circuit 903. The compute logic circuit 901 includes an OR-AND-Invert gate (OAI) gate 905, a third NOR gate 907, and a compute inverter 909. The ripple carry generation circuit 903 includes a plurality of COG NAND gates 903a, and 903b.

In an embodiment, the compute logic circuit 901 is configured to generate a first compute signal (C1) and a second compute signal (C2). As shown, the first NAND signal (e.g., A0nandB0) generated by the first logic circuit, the second NAND signal (e.g., A1nandB1), and the second NOR signal (e.g., A1norB1) signals generated by the third logic circuit, are fed to the OAI gate 905. The OAI gate 905 performs an OR operation on the second NOR signal (e.g., A1norB1) and the first NAND signal (e.g., A0nandB0). The OAI gate 905 then performs an AND operation on the output of the first OR operation and the second NAND signal (e.g., A1nandB1) to generate the second compute signal (C2). In an embodiment, the first NOR signal (e.g., A0norB0) and the second NOR signal (e.g., A1norB1) are fed to the third NOR gate 907 to generate the first compute signal (C1).

In a same or different embodiment, the ripple carry generation circuit 903 is configured to generate an output carry signal (CO) using C1 and C2. In particular, C1 and the input carry signal (CI) are fed to a first COG NAND gate 903a to generate an intermediate compute signal (CMP). The intermediate compute signal (CMP) and C2 are further fed to a second COG NAND gate 903b to generate the output carry signal (CO).

It should be noted that the first bit generation circuits as discussed in reference to FIGS. 3-5 may correspond to the first bit generation circuits 201a of FIG. 2. Similarly, the second bit generation circuits as discussed in reference to FIGS. 6-8 may be correspond to the second bit generation circuits 201b of FIG. 2. Further, the COG circuit of FIG. 9 may correspond to the COG circuit 203 of FIG. 2. Thus, in various embodiments of the present disclosure, the disclosed ripple carry full adder circuit 200 generates the first and second sum output signals S0, S1 and output carry signal CO.

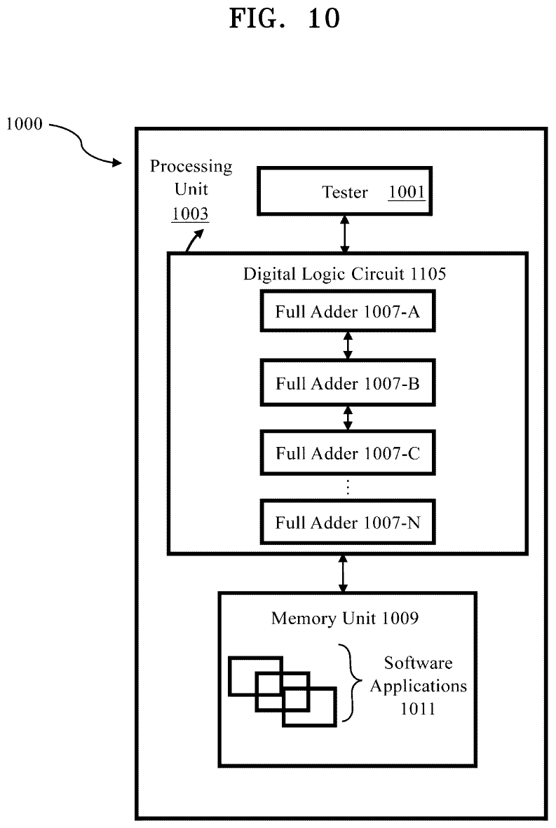

Referring now to FIG. 10, a computing system 1000 is illustrated, in accordance with some example embodiments of the present inventive concepts. The integrated circuits 201a, 201b, and 203 as discussed in reference to FIGS. 2-9 may be implemented in the computing system 1000, according to some example embodiments of the present disclosure. The computing system 1000 is, or is incorporated into but not limited to, a smartphone, a personal digital assistant, a personal computer, smartwatches, fitness trackers, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine or any other type of electronic system. Further, while a single computing system 1000 is illustrated, the term “system” shall also be taken to include any collection of systems or sub-systems that individually or jointly execute a set, or multiple sets, of instructions to perform one or more computer functions.

In some example embodiments, the computing system 1000 comprises a tester 1001, a mega cell, or a system-on-chip (SoC) which includes control logic such as a processing unit 1003 (Central Processing Unit), a Digital Logic Circuit 1005 including a plurality of full adders (1007-A through 1007-N), and/or a memory unit 1009 (e.g., random access memory (RAM).

The processing unit 1003 can be, for example, a CISC-type (Complex Instruction Set Computer) CPU, a RISC-type CPU (Reduced Instruction Set Computer), a digital signal processor (DSP), or a graphics processing unit (GPU). The processing unit 1003 may be a component in a variety of systems. For example, the processing unit 1003 may be part of a standard personal computer or a workstation. The processing unit 1003 may be one or more general processors, digital signal processors, application-specific integrated circuits, field-programmable gate arrays, servers, networks, digital circuits, analog circuits, combinations thereof, or other devices for analyzing and processing data. The processing unit 1003 may implement a software program, such as code generated manually (e.g., programmed).

The memory unit 1009 (which can be memory such as RAM, flash memory, or disk storage) stores one or more software applications 1011 (e.g., embedded applications) that, when executed by the processing unit 1003, perform any suitable function associated with the computing system 1000. The memory unit 1009 may include but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like.

The tester 1001 comprises logic that supports testing and debugging of the computing system 1000 executing the software applications 1011. For example, the tester 1001 can be used to emulate a defective or unavailable component(s) of the computing system 1000 to allow verification of how the component(s), that were present on the computing system 1000 and would perform in various situations (e.g., how the component(s) would interact with the software applications 1011). In this way, the software application 1011 can be debugged in an environment that resembles a post-production operation.

The Digital Logic Circuit 1005 is used during the execution of the software application 1011. At least one full adder of the plurality of full adders (1007-A through 1007-N) includes, or is similar to, the full adder circuitry shown in FIGS. 2-9 in connection and operation.

The disclosed ripple carry full adder circuit is more efficient when high transition time signals nets driving by long metal wires are used for adder with carry-in (ADDF) computing. Further, the ripple carry generation circuit comprises two back-to-back NAND gates. This arrangement of NAND gates balances out the rise/fall transitions. The disclosed ripple carry full adder circuit ensures full rail to rail VDD swing and the topology is optimized to provide area benefit in layout. CI input pins and internal nets are now connected to less number of transistors, thereby decreasing the load capacitance on the nets. Due to reduced load capacitance, performance on the CI to CO path is increased. Further, the optimized circuit on the sum output signal generation leads to a very compact design.

In the foregoing discussion, the term “connected” means at least either a direct electrical connection between the devices connected or an indirect connection through one or more passive intermediary devices. The term “circuit” means at least either a single component or a multiplicity of passive components, that are connected together to provide a desired function. Also, the terms “coupled to” or “couples with” (and the like) are intended to describe either an indirect or direct electrical connection. Thus, as an example, if an electronic device is coupled to another electronic device, that connection can be through a direct electrical connection, or through an indirect electrical connection via other devices and connections.

While specific language has been used to describe the disclosure, any limitations arising on account of the same are not intended. As would be apparent to a person in the art, various working modifications may be made to implement the inventive concepts as taught herein.

The drawings and the forgoing description give examples of example embodiments. Those skilled in the art will appreciate that one or more of the described elements may be combined into a single functional element. Alternatively, certain elements may be split into multiple functional elements. Elements from one example embodiment may be added to another example embodiment.

Also, those acts that are not dependent on other acts may be performed in parallel with the other acts. The scope of example embodiments is by no means limited by these specific examples. Numerous variations, whether explicitly given in the specification or not, such as differences in structure, dimension, and use of material, are possible. The scope of example embodiments is at least as broad as given by the following claims.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Benefits, other advantages, and solutions to problems have been described above with regard to specific example embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A ripple carry full adder circuit comprising:
a sum generation circuit, the sum generation circuit comprising a first bit generation circuit and a second bit generation circuit, wherein the first bit generation circuit is configured to generate a first output sum signal, and the second bit generation circuit is configured to generate a second output sum signal; and
a carry bit generation circuit configured to generate an output carry signal, wherein the carry bit generation circuit comprises a compute logic circuit and a ripple carry generation circuit, the ripple carry generation circuit comprising a plurality of carry bit generation NAND gates;
wherein the first bit generation circuit comprises a first NOR gate, a first logic circuit, a first inverter, and a second logic circuit, and
wherein the second bit generation circuit comprises a second NOR gate, a third logic circuit, a fourth inverter, and a fourth logic circuit.

2. The circuit as claimed in claim 1, wherein the carry bit generation circuit is further configured to:
generate a first compute output signal using the compute logic circuit based on a first NOR signal generated by the first bit generation circuit and a second NOR signal generated by the second bit generation circuit;
generate a second compute output signal using the compute logic circuit based on a first NAND signal generated by the first bit generation circuit, a second NAND signal generated by the second bit generation circuit, and the second NOR signal;
generate an intermediate compute signal using the ripple carry generation circuit based on an input carry signal and the first compute output signal; and
generate the output carry signal using the ripple carry generation circuit based on the intermediate compute signal and the second compute output signal.

3. The circuit as claimed in claim 1, wherein the compute logic circuit includes an OR-AND-Invert gate, a third NOR gate and a compute inverter.

4. The circuit as claimed in claim 1, wherein the first logic circuit comprises a first NAND gate connected in parallel with a first AND-OR-Invert gate and a second AND-OR-Invert gate, and wherein the second logic circuit comprises a first transmission gate and a first tristate inverter gate.

5. The circuit as claimed in claim 4, wherein the first bit generation circuit is configured to:
generate a first NOR signal using the first NOR gate based on a first input bit and a second input bit;
generate a first XOR signal and a first NAND signal using the first logic circuit based on the first NOR signal, the first input bit and the second input bit;
generate an inverted carry signal using the first inverter based on an input carry signal; and
generate the first output sum signal using the second logic circuit based on the first XOR signal, the input carry signal and the inverted carry signal.

6. The circuit as claimed in claim 4, wherein the first bit generation circuit is configured to:
generate an intermediate carry out signal using the second AND-OR-Invert gate based on a first NOR signal, a first XOR signal and an inverted carry signal.

7. The circuit as claimed in claim 1, wherein the first logic circuit comprises a first NAND gate connected in parallel with a first AND-OR-Invert gate and a second AND-OR-Invert gate, and wherein the second logic circuit comprises a pass transistor, a first transmission gate, a second inverter, and a third inverter.

8. The circuit as claimed in claim 7, wherein the first bit generation circuit is configured to:
generate a first NOR signal using the first NOR gate based on a first input bit and a second input bit;
generate a first XOR signal and a first NAND signal using the first logic circuit based on the first NOR signal, the first input bit and the second input bit;
generate an inverted carry signal using the first inverter based on an input carry signal;
generate a first XNOR signal using the second inverter based on the first XOR signal; and
generate the first output sum signal using the second logic circuit based on the first XOR signal, the first XNOR signal, the third inverter, and the inverted carry signal.

9. The circuit as claimed in claim 7, wherein the first bit generation circuit is further configured to:
generate an intermediate carry out signal using the second AND-OR-Invert gate based on a first NOR signal, a first XOR signal and an inverted carry signal.

10. The circuit as claimed in claim 1, wherein the first logic circuit comprises a first NAND gate connected with a second NAND gate and a second inverter, and wherein the second logic circuit comprises a first transmission gate and a first tristate inverter gate.

11. The circuit as claimed in claim 10, wherein the first bit generation circuit is configured to:
generate a first OR signal using the first NOR gate and the second inverter based on a first input bit and a second input bit;
generate an inverted carry signal using the first inverter based on an input carry signal;
generate a first XNOR signal using the first logic circuit based on the first OR signal, the first input bit and the second input bit; and
generate the first output sum signal using the second logic circuit based on the first XNOR signal, the input carry signal, and the inverted carry signal.

12. The circuit as claimed in claim 10, wherein the first bit generation circuit further comprises a third NAND gate connected with a fourth NAND gate and the first bit generation circuit is further configured to:
generate an intermediate carry out signal using the third NAND gate and the fourth NAND gate based on a first OR signal, a first NAND signal, and an input carry signal.

13. The circuit as claimed in claim 1, wherein the second bit generation circuit is configured to:
generate a second NOR signal using the second NOR gate based on a third input bit and a fourth input bit;
generate a second XOR signal and a second NAND signal using the third logic circuit based on the second NOR signal, the third input bit and the fourth input bit;
generate the second output sum signal using the fourth logic circuit and the fourth inverter based on the second XOR signal, an intermediate carry out signal generated by the first bit generation circuit and an inverted signal of the intermediate carry out signal.

14. The circuit as claimed in claim 13, wherein the third logic circuit comprises a fifth NAND gate connected in parallel with a third AND-OR-Invert gate and wherein the fourth logic circuit comprises a second transmission gate and a second tristate inverter gate.

15. The circuit as claimed in claim 13, wherein the third logic circuit comprises a fifth NAND gate connected in parallel with a third AND-OR-Invert gate, and wherein the fourth logic circuit comprises a plurality of pass transistors, a second transmission gate, and a fifth inverter.

16. The circuit as claimed in claim 1, wherein the third logic circuit comprises a fifth NAND gate connected with a sixth NAND gate and a fifth inverter, and wherein the fourth logic circuit comprises a second transmission gate and a second tristate inverter gate.

17. The circuit as claimed in claim 16, wherein the second bit generation circuit is configured to:
generate a second NOR signal using the second NOR gate based on a third input bit and a fourth input bit;
generate a second XNOR signal using the third logic circuit based on the second NOR signal, the third input bit and the fourth input bit; and
generate the second output sum signal using the fourth logic circuit and the fourth inverter based on the second XNOR signal, an intermediate carry out signal generated by the first bit generation circuit and an inverted signal of the intermediate carry out signal.

18. An electronic device comprising a ripple carry full adder circuit, wherein the ripple carry full adder circuit comprises:
a sum generation circuit, the sum generation circuit comprising a first bit generation circuit and a second bit generation circuit, wherein the first bit generation circuit is configured to generate a first output sum signal, and the second bit generation circuit is configured to generate a second output sum signal; and
a carry bit generation circuit configured to generate an output carry signal, wherein the carry bit generation circuit comprises a compute logic circuit and a ripple carry generation circuit, the ripple carry generation circuit having a plurality of carry bit generation NAND gates;
wherein the first bit generation circuit comprises a first NOR gate, a first logic circuit, a first inverter, and a second logic circuit, and
wherein the second bit generation circuit comprises a second NOR gate, a third logic circuit, a fourth inverter, and a fourth logic circuit.

19. The electronic device as claimed in claim 1, wherein the compute logic circuit includes an OR-AND-Invert gate, a third NOR gate and a compute inverter; and
wherein the first logic circuit comprises a first NAND gate connected in parallel with a first AND-OR-Invert gate and a second AND-OR-Invert gate, and wherein the second logic circuit comprises a first transmission gate and a first tristate inverter gate.

20. The electronic device as claimed in claim 1, wherein the first logic circuit comprises a first NAND gate connected in parallel with a first AND-OR-Invert gate and a second AND-OR-Invert gate, and wherein the second logic circuit comprises a pass transistor, a first transmission gate, a second inverter, and a third inverter.
